(19) United States
(12) Patent Application Publication
(10) Pub. No.: US 2009/0071612 A1
(43) Pub. Date: Mar. 19, 2009

(54) Carrier assembly for vertical blind

(76) Inventor: Hans Hung, Sihu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,103

(22) Filed: Sep. 19, 2007

(51) Int. Cl. E06B 9/36

(52) U.S. Cl. 160/174 V; 74/420

(57) ABSTRACT

A slat support for a vertical blind includes a gear on a top end thereof. The gear includes a toothed section and a stop section. The toothed section includes a plurality of circumferentially spaced radial gear teeth. A thickness area between upper and lower faces of the stop section is at least partially located within a tooth thickness area of the radial gear teeth of the toothed section. The toothed section meshes with a gear device that can be driven upon rotation of a splined tilt rod. When rotation to the leftmost position or the rightmost position of the gear device is reached, the stop portion is too large to engage with and stopped by the gear device, preventing further movement of the gear device and the gear of the slat support. Gear skipping problem is reliably avoided.

### BACKGROUND OF THE INVENTION

The present invention relates to a carrier assembly for a vertical blind and, more particularly, to a carrier assembly for a vertical blind including an automatic stopping mechanism to prevent skipping of gears to retain proper alignment of the slats of the vertical blind.

Vertical blinds are well known in the prior art and typically include a plurality of vertically depending slats or blinds each of which is rotatably mounted to a carrier assembly slideably mounted on a splined tilt rod that extends a horizontal length of a header. The carrier assemblies allow the slats to be positioned in “open” or “closed” positions or a position therebetween. Rotation of the tilt rod causes uniform rotation of the slats through gears mounted in the carrier assemblies.

A common problem existing in vertical blinds is the tendency of one or more of the slats to skip their gear mechanisms, leading to misaligned slats. Various attempts have been made to solve this problem. U.S. Pat. No. 5,056,578 to Helver discloses a carrier assembly including a gear means that has a drive gear formed on a support finger. The gear means further includes a first gear connected in driven engagement to the tilt rod and a second gear connected in driving engagement to the drive gear and the support finger and movable with the first gear upon rotation of the tilt rod. A stop means is provided in the form of two outwardly extending projections integrally formed on the drive gear and in spaced relation to each other. Upon rotation of the drive gear, one of the projections will engage the teeth of the second gear causing a stopping of relative rotation therebetween. The stop means therefore facilitates “automatic” alignment when one of the slats associated with a particular support finger becomes misaligned. The projections are formed outside a tooth thickness area of the gear teeth of the drive gear. In a case that one of the projections has engaged and is, thus, stopped by the teeth of the second gear, if the operator is not aware of this situation and continues to rotate the tilt rod and hence the drive gear, the drive gear will be forcibly rotated and cause the projection to flex, leading to misalignment of the slats and even damage to the projection and/or the second gear. This is because the gear teeth of the drive gear mesh with the gear teeth of the second gear and, thus, can be forcibly rotated easily. The realignment function and the misalignment preventing function will be lost.

U.S. Pat. No. 6,105,656 to Hernandez et al. discloses a carrier assembly including a similar linear gear for cooperating with a tilt rod for rotating a round gear formed on a slat support. The round gear is connected to a neck that terminates in a base. An arc-shaped stop member is located on the base and radially extends a distance from the neck equal to the base. Furthermore, the stop member radially extends a distance from the neck greater than the gear teeth of the round gear. When rotation to the leftmost position or the rightmost position of the linear is reached, the stop member comes into direct contact with and urges the respective end of the linear gear against a track wall which prevents further movement of the linear gear and the round gear. Such a carrier assembly is also capable of preventing misalignment of the slats. However, the arc-shaped stop member is formed outside the tooth thickness area of the gear teeth of the round gear. Similar to the above patent, misalignment and/or damage to the linear gear and/or the round gear will occur if the operator is not aware of the situation that the linear gear has reached its leftmost or rightmost position of rotation and still continues to rotate the tilt rod.

A need exists for a carrier assembly that avoids damage to the gears while preventing misalignment of slats.

### BRIEF SUMMARY OF THE INVENTION

The present invention solves this need and other problems in the field of vertical blinds by providing a slat support for a carrier housing of a vertical blind. The slat support is adapted to be rotatably mounted to a carrier housing of a vertical blind. The slat support includes a lower end adapted to be coupled with a slat of the vertical blind. The slat support further includes a gear on a top end thereof. The gear includes a toothed section and a stop section arranged in a circumferential direction. The toothed section includes a plurality of radial gear teeth spaced in the circumferential direction. The stop section includes upper and lower faces defining a thickness area therebetween. The thickness area of the stop section is at least partially located within a tooth thickness area of the radial gear teeth of the toothed section.

The toothed section meshes with a gear device that is mounted in the carrier housing and that can be driven upon rotation of a splined tilt rod of the vertical blind. When rotation to the leftmost position or the rightmost position of the gear device is reached, the stop portion is too large to engage with and stopped by the gear device, preventing further movement of the gear device and the gear of the slat support. Gear skipping problem is, thus, reliably avoided.

Preferably, the thickness of the thickness area of the stop section is the same as the tooth thickness of the radial gear teeth of the toothed section.

Preferably, the toothed section includes a groove between a pair of gear teeth adjacent to each other. The stop section further includes two sides spaced in the circumferential direction. The maximum width between the sides of the stop section is greater than the maximum width of the groove. Preferably, the sides of the stop section are respectively contiguous to two ends of the toothed section.

Preferably, the stop section radially extends outward beyond the toothed section.

Preferably, the toothed section and the stop section together cover 360 degrees.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a partial, perspective view of a vertical blind utilizing a plurality of carrier assemblies according to the preferred teachings of the present invention.

FIG. 2 shows a perspective view of one of the carrier assemblies of FIG. 1.

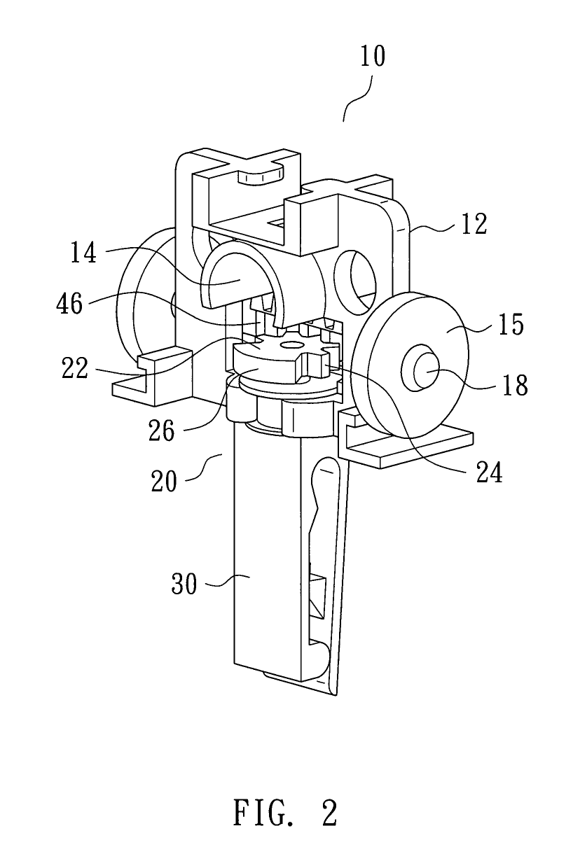

FIG. 3 shows an exploded perspective view of the carrier assembly of FIG. 2.

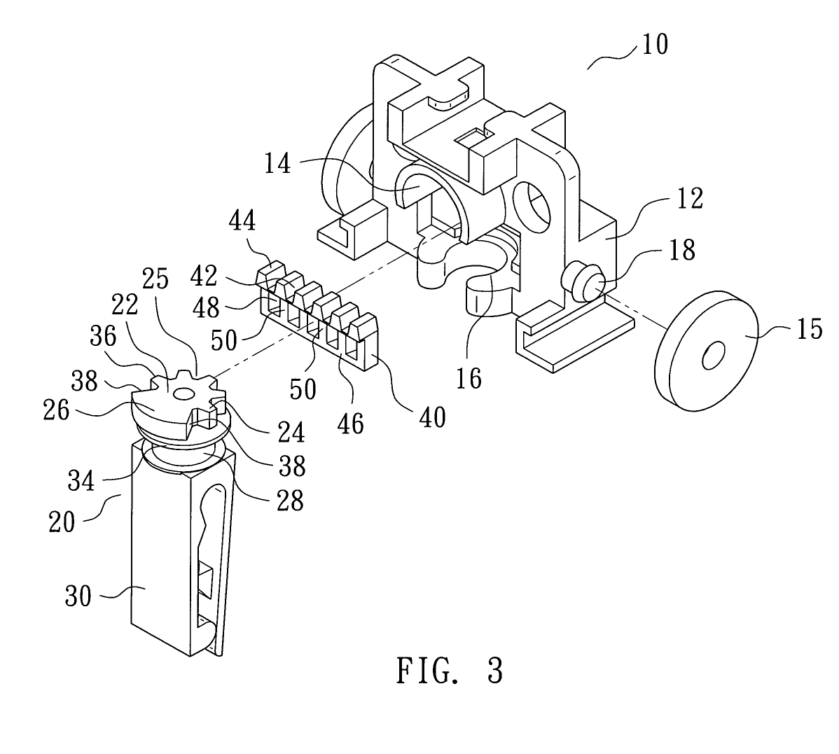

FIG. 4 shows a cross sectional view of the carrier assembly of FIG. 2 depicting a rightmost position of rotation.

FIG. 5 shows a cross sectional view of the carrier assembly of FIG. 2 depicting a leftmost position of rotation.

FIG. 6 shows a rear view of the carrier assembly of FIG. 2.

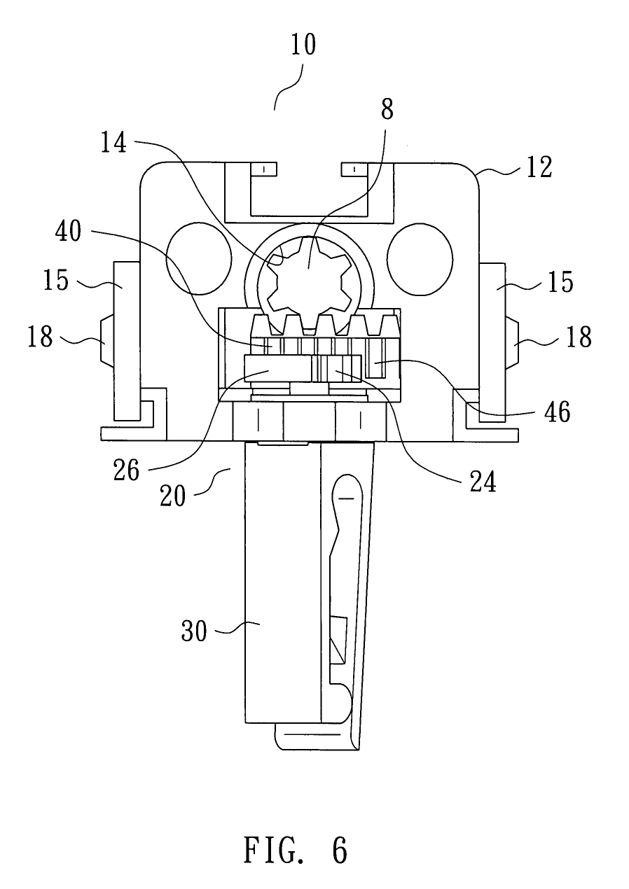

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “upper”, “end”, “portion”, “section”, “longitudinal”, “radial”, “circumferential”, “lateral”, “vertical”, “outward”, “length”, “thickness”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

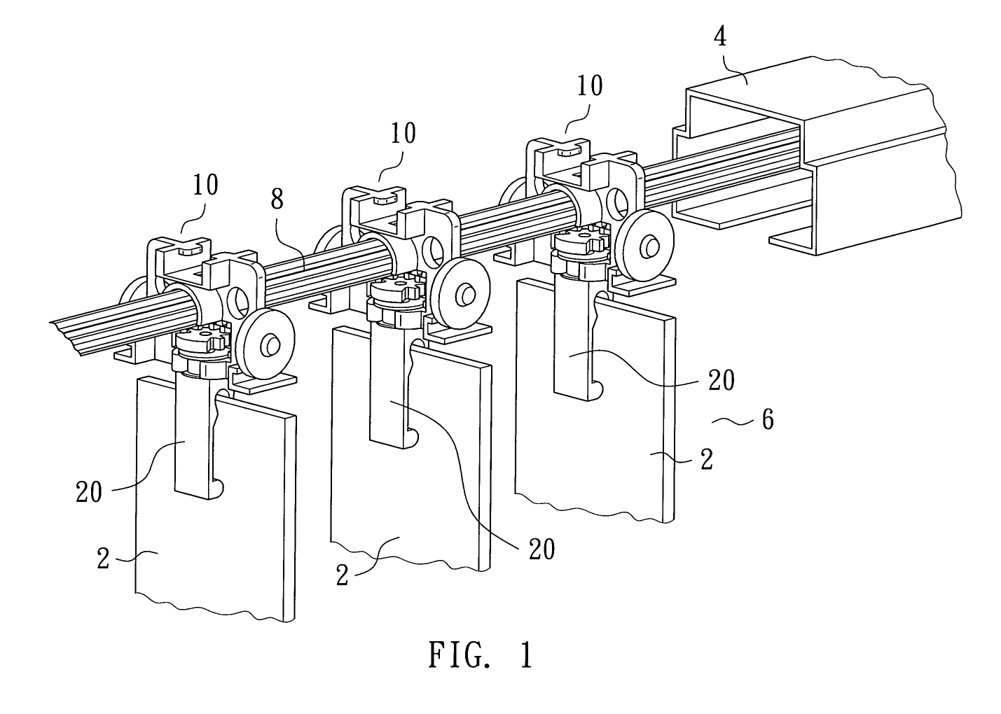

A vertical blind assembly 6 is illustrated in FIG. 1 and generally includes a header 4, a splined tilt rod 8 extending along a length of the header 4, and a plurality of blinds or slats 2 each depending from a carrier assembly according to the preferred teachings of the present invention shown in the drawings and generally designated 10.

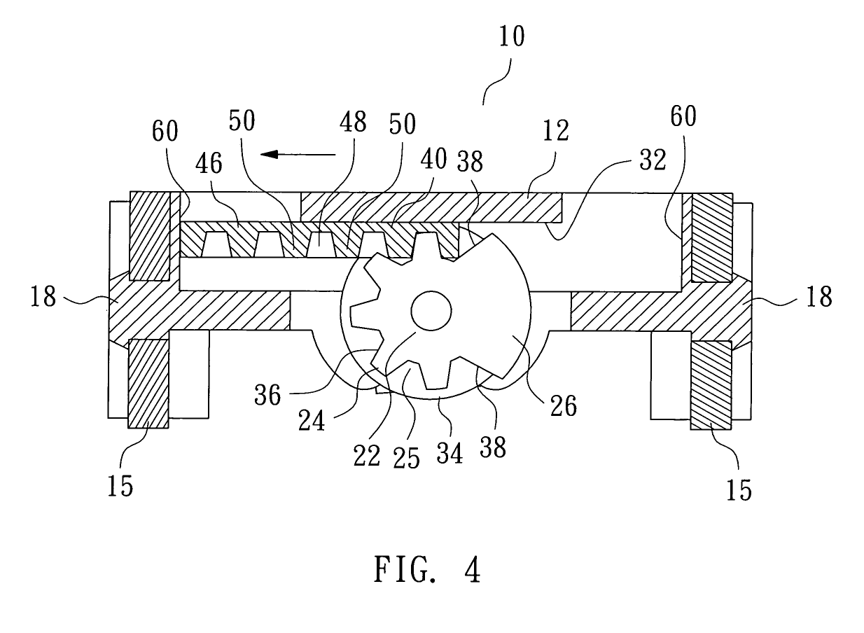

According to the preferred form, the carrier assembly 10 includes a one-piece housing 12 made by injection molding. An axle 18 is formed on each of two opposite lateral sides of the housing 12, and a roller 15 is rotatably mounted on the axle 18 to allow the carrier assembly 10 to travel along the length of the header 4. The housing 12 further includes an aperture 14 through which the tilt rod 8 rotatably extends. Furthermore, the housing 12 includes a linear track 32 (FIG. 4) extending in a direction transverse to the longitudinal axis of the tilt rod 8 and defined by two opposite track walls 60. Further, the housing 12 includes a coupling portion 16.

In the preferred form shown, the carrier assembly 10 further includes a gear device 40 for transmitting rotational movement of the tilt rod 8 to the slat 2. In the most preferred form shown, the gear device 40 includes a linear first gear 42 having a plurality of spaced, upright gear teeth 44 meshed with the tilt rod 8 so that rotational movement of the tilt rod 8 causes linear movement of the first gear 42 in the linear track 32 of the housing 12. The gear device 40 further includes a linear second gear 46 extending downward from a bottom side of the linear first gear 42 and having a plurality of spaced gear teeth 50 extending in a direction parallel to the first gear 42. An opening 48 is formed between two adjacent gear teeth 50 and has a length in a longitudinal direction of the second gear 46. The gear device 40 may be made of injection molding plastic as a continuous monolithic piece. Other methods for manufacturing the gear device 40 would be within the skill of the art.

According to the preferred form shown, the carrier assembly 10 further includes a slat support 20 having a base 34 and a third gear 22 formed on a top of the base 34. The base 34 includes a channel 28 removably and rotatably coupled with the coupling portion 16 of the housing 12. The base 34 further includes a slat coupling portion 30 below the channel 28 for coupling with an upper end of the slat 2. The third gear 22 includes a toothed section 36 covering an area of the base 34 and a stop section 26 covering the remaining area of the base 34. Namely, the toothed section 36 and the stop section 26 together cover 360 degrees. The toothed section 36 includes a plurality of circumferentially spaced radial gear teeth 24 meshed with the openings 48 of the second gear 46. A groove 25 is defined between a pair of gear teeth 24 adjacent to each other. When the tilt rod 8 rotates along its longitudinal axis, the gear device 40 moves linearly in the linear track 32 in the housing 12 to cause rotation of the third gear 22 and the slat 2 depending from the slat support 20. The stop section 26 has a thickness area between an upper face and a lower face thereof and located within a tooth thickness area of the gear teeth 24 of the toothed section 36. Furthermore, the stop section 26 has a maximum width between two opposite sides 38 spaced in the circumferential direction. In the most preferred form shown, the thickness of the thickness area between the upper and lower faces of the stop section 26 is the same as the tooth thickness of the gear teeth 24 of the toothed section 36 of the third gear 22, and an outer end of the stop section 26 radially extends beyond an outer periphery of the base 34 and beyond the toothed section 36. Furthermore, the maximum width of the stop section 26 is larger than the length of the opening 48 of the second gear 46 and larger than the maximum width of the groove 25 between two adjacent teeth 24 of the toothed section 36. Thus, the stop section 26 is too larger to engage with the opening 48. The whole slat support 20 can be made by injection molding. Other methods for manufacturing the slat support 20 would be within the skill of the art.

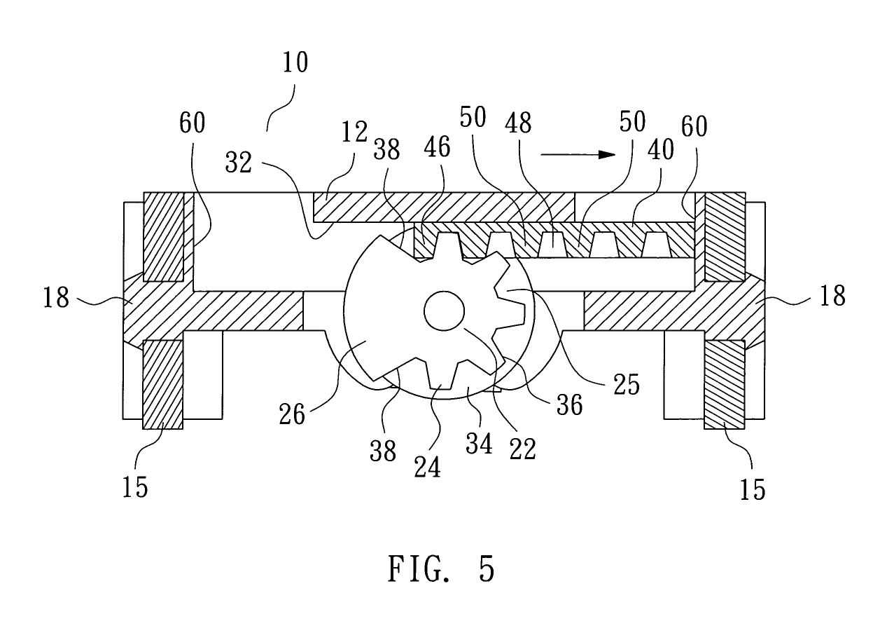

Now that the basic construction of the carrier assembly 10 of the preferred teachings of the present invention has been explained, the operation and some of the advantages of the carrier assembly 10 can be set forth and appreciated. In normal operation, when an operator operates rotates the tilt rod 8, the gear device 40 moves linearly in the linear track 32 in the housing 12 due to engagement between the first gear 42 and the tilt rod 8. The linear movement of the gear device 40 causes rotation of the slat 2 due to engagement between the third gear 22 and the second gear 46. When rotation to the leftmost position (FIG. 4) or the rightmost position (FIG. 5) of the gear device 40 is reached, the stop portion 26 of the third gear 22 comes in contact with and is stopped by the second gear 46, for the stop portion 26 is too large to engage with the opening 48 of the second gear 46. Furthermore, one of the sides 38 of the stop portion 26 comes in contact with and urges one of two ends of the second gear 46 against one of the track walls 60, preventing further movement of the gears 46 and 22. Gear skipping problem encounters in the prior art vertical blinds is, thus, reliably avoided. Another advantage of the stop portion 26 of the third gear 22 is improved structural strength. This is because the stop portion 26 is located within the tooth thickness area of the gear teeth 24 of the third gear 22, not outside the tooth thickness area of the gear teeth 24. Specifically, when the stop portion 26 comes in contact with and is stopped by the second gear 46, no gear teeth 24 on the third gear 22 is going to mesh the second gear 46 in the rotating direction. This reliably stops further rotation of the third gear 22. Even though the operator is not aware of this situation and continues to rotate the tilt rod 8, damage to the improved structural strength of the third gear 22 and its stop portion 26 is impossible, for the operator will immediately feel the great resistance from the third gear 22. Undesired continued rotation of the slat support 20 and the slat 2 are reliably avoided, and disorientation of the slat 2 is avoided accordingly.

Now that the basic teachings of the present invention have been explained, many extensions and variations will be obvious to one having ordinary skill in the art. For example, the gear device 40 can be of any forms for transmitting the rotational force to the third gear 22 of the carrier assembly 10 according to the preferred teachings of the present invention. The portions of the slat support 20 other than the third gear 22 can be of any desired form as conventional including but not limited to of a commercially available type. Furthermore, the housing 12 can be of any desired form as conventional including but not limited to of a commercially available type. The thickness of the stop section 26 may be larger or smaller than the tooth thickness of the gear teeth 24 of the toothed section 36 of the third gear 22 without affecting its function. Further, the stop section 26 may extend in its thickness direction beyond the tooth thickness area of the toothed section 36 of the third gear 22 without affecting its function. Further, the stop section 26 may extend in the radial direction to an extent not beyond the gear teeth 24 of the third gear 22. Further, when rotation to the leftmost position or the rightmost position of the gear device 40 is reached, the side 38 of the stop portion 26 does not have to be in contact with and urge one of two ends of the second gear 46 against the track wall 60, for the stop portion 26 that is too large to engage with the opening 48 of the second gear 46 has come in contact with and been stopped by the second gear 46. This arrangement also avoids further movement of the gears 46 and 22 and the gear skipping problem.

The carrier assembly 10 according to the preferred teachings of the present invention can be easily manufactured at low costs. Assembly of the slat support 20 can easily be attained with the stop section 26 of the third gear 22 facing outward without the risk of improper assembly.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A slat support for a carrier housing of a vertical blind, the slat support being adapted to be rotatably mounted to a carrier housing of a vertical blind, with the slat support comprising a lower end adapted to be coupled with a slat of the vertical blind, with the slat support further including a gear on a top end thereof, with the gear including a toothed section and a stop section arranged in a circumferential direction, with the toothed section including a plurality of radial gear teeth spaced in the circumferential direction, with the stop section including upper and lower faces defining a thickness area therebetween, and with the thickness area of the stop section being at least partially located within a tooth thickness area of the radial gear teeth of the toothed section.

2. The slat support as claimed in claim 1, with the thickness area of the stop section having a thickness the same as a tooth thickness of the radial gear teeth of the toothed section.

3. The slat support as claimed in claim 1, with the toothed section including a groove between a pair of gear teeth adjacent to each other, with the groove having a maximum width, with the stop section further including two sides spaced in the circumferential direction, with the sides of the stop section having a maximum width therebetween, and with the maximum width of the stop section being greater than the maximum width of the groove.

4. The slat support as claimed in claim 3, with the sides of the stop section being respectively contiguous to two ends of the toothed section.

5. The slat support as claimed in claim 1, with the stop section radially extending outward beyond the toothed section.

6. The slat support as claimed in claim 1, with the toothed section and the stop section together covering 360 degrees.
